(19) United States
(12) Patent Application Publication
(10) Pub. No.: US 2024/0180148 A1
(43) Pub. Date: Jun. 6, 2024

(54) EFFICIENT BIOCOMPATIBLE CRYOPRESERVATION MEDIUM THAT ELIMINATES THE NEED FOR CELL PERMEATING CRYOPROTECTANTS

(71) Applicants: CRYOCRATE LLC, Columbia, MO (US); THE CURATORS OF THE UNIVERSITY OF MISSOURI, Columbia, MO (US)

(72) Inventors: Xu Han, Columbia, MO (US); Henry White, Columbia, MO (US); Peter Koulen, Columbia, MO (US)

(21) Appl. No.: 18/553,231

(22) PCT Filed: Apr. 5, 2022
(86) PCT No.: PCT/US2022/023439

§ 371 Date: Sep. 29, 2023

Related U.S. Application Data
(60) Provisional application No. 63/170,673, filed on Apr. 5, 2021.

(51) Int. Cl. A01N 1/02

(52) U.S. Cl. CPC A01N 1/0221

(57) ABSTRACT

A cryopreservation medium including: a first cryoprotective particle or macromolecule: a second cryoprotective particle or macromolecule: and an aqueous liquid, wherein the first cryoprotective particle or macromolecule is hydrophilic and has a spherical shape when dissolved or suspended in the aqueous liquid, and wherein the second cryoprotective particle or macromolecule has an affinity for the first cryoprotective particle or macromolecule and an affinity for the plasma membrane of the cell.

### CROSS-REFERENCE TO RELATED APPLICATION

This application is based on and claims priority to U.S. Provisional Application Ser. No. 63/170,673 filed on Apr. 5, 2021, which is hereby incorporated herein by Reference

### STATEMENT REGARDING FEDERALLY SPONSORED RESEARCH OR DEVELOPMENT

This invention was made with United States Government support under NIH 2R44OD020163-02A1 awarded by the United States National Institutes of Health (NIH) Small Business Innovation Research (SBIR). The Government has certain rights to this invention.

### FIELD OF THE INVENTION

The present disclosure is directed to the fields of cryobiology, cryopreservation, and ice formation control technologies, as well as storage of biological and clinical samples.

### BACKGROUND

Cryopreservation is a technique that allows biological materials to be stored at temperatures below the freezing point of water (i.e., 0° C.). Cryopreservation is a slowly progressing field due in large part to a limitation in understanding the mechanisms of ice formation at nanoscale dimensions plus a lack of efficient measures to control ice formation on a cellular scale. Practical cryostorage began when it was surprisingly discovered that animal semen could be cryopreserved using glycerol rich media in 1949 (Polge C, Smith Au, Parkes As. Revival of spermatozoa after vitrification and dehydration at low temperatures. Nature. 1949 Oct. 15; 164(4172):666). Since then, existing cryopreservation technologies (except a few that can be adopted only for few cell types with unique biophysical features) and all products in the marketplace, remain dependent on the use of various biologically incompatible (i.e., cell permeating and reactive) small molecule cryoprotectants despite decades of efforts in innovating cryopreservation technologies. These cell permeating cryoprotectants include but are not limited to, glycerol, dimethyl sulfoxide (DMSO), ethylene glycol, and propanediol. Unfortunately, inclusion of these small molecule reagents in cryopreservation media is the cause of numerous technical, practical, and regulatory issues. More crucially, countless cell and tissue types respond poorly to existing cryopreservation protocols, and exhibit low post-thaw viability and impaired functionality.

Facing recent rapid advances in cell-based tissue engineering and regenerative medicine, as well as continued development of transplantation technologies using human donor or xenogeneic tissues, there exists an urgent need for an improved cryopreservation medium and cryopreservation methods that are clinically practical and that overcome these long-existing challenges. In particular, there exists a need for an efficient cryopreservation medium that eliminates the need for inclusion of a cell permeating cryoprotectant and methods of use that are practical, as well as mitigate complications and inefficiencies associated with cell permeating cryoprotectants.

### SUMMARY

Disclosed herein is an efficient cryopreservation medium that eliminates need for inclusion of a cell permeating cryoprotectant. Methods of using the cryopreservation medium are also disclosed.

Disclosed herein is a cryopreservation medium comprising: a first cryoprotective particle or macromolecule; a second cryoprotective particle or macromolecule; and an aqueous liquid, wherein the first cryoprotective particle or macromolecule is hydrophilic and has a spherical shape when dissolved or suspended in the aqueous liquid, and wherein the second cryoprotective particle or macromolecule has an affinity for the first cryoprotective particle or macromolecule and an affinity for a plasma membrane of a cell or a lipid membrane of a lipid membrane bound biological structure.

Disclosed herein also is a method of protecting a lipid membrane of a lipid membrane bound biological structure comprising, contacting the lipid membrane bound biological structure with a cryopreservation medium prior to cooling the lipid membrane bound biological structure to a temperature of about −70° C. to about −273° C., wherein nano scale cubic ice is formed around the lipid membrane at the temperature of about −70° C. to about −273ºC.

The above described and other features are exemplified by the following figures and detailed description.

### BRIEF DESCRIPTION OF THE DRAWINGS

The following figures are exemplary embodiments wherein the like elements are numbered alike.

FIG. 1 is an illustration of the working mechanism of the cryopreservation medium of the present invention.

FIG. 2 shows the experimental results that reveal the formation of nano scale cubic ice in the medium containing Ficoll 70 through cryogenic X-ray diffraction and transmission electron microscopy of the replica of the freeze-fractured samples.

FIG. 3 shows the experimental results of using fluorescence microscopy to demonstrate that the chondroitin sulfate A sodium salt molecules significantly promote the affinity between the Ficoll 70 molecules and cell membranes.

FIG. 4 shows the experimental results of using cryomicroscopy to demonstrate that the medium of the present invention prevents intracellular ice formation during freezing.

FIG. 5 shows the efficiency of the medium of the present invention in cryopreservation of Sf9 cells at both −80° C. and liquid nitrogen temperatures.

FIG. 6 shows the efficacy of the cryopreservation medium of the present invention in cryopreservation of human adipose stem cells at −80° C.

FIG. 7 shows the efficacy of the cryopreservation medium of the present invention in cryopreservation of bovine chromaffin cells at −80° C.

FIG. 8 shows the efficacy of the cryopreservation medium of the present invention in cryopreservation of human skin grafts at −80° C.

FIG. 9 shows the efficacy of the cryopreservation medium of the present invention in cryopreservation of human corneal limbal tissues at −80° C.

FIG. 10 shows the efficacy of the cryopreservation medium of the present invention in cryopreservation of bovine adrenal gland tissues at −80° C.

FIG. 11 shows the efficacy of the cryopreservation medium of the present invention in cryopreservation of 2D iPSC-derived RPE tissues at −80° C.

FIG. 12 shows the efficacy of the cryopreservation medium of the present invention in cryopreservation of 3D differentiated neuronal tissues at −80° C.

### DETAILED DESCRIPTION

Cryopreservation is a technique that allows biological materials to be stored at very low temperatures, typically from about −80° C. to −196° C., e.g., in mechanical deep freezers or liquid nitrogen cryogenic freezers or tanks. Cryopreservation or cryostorage is known to store such biological materials for a relatively long period of time, potentially indefinitely, with no functional degradation, or substantially limited degradation, of the biological materials. Practical cryostorage began in 1949 when it was serendipitously discovered that animal semen could be cryopreserved using glycerol-rich media. Ever since then, for cell cryopreservation, nearly all cryopreservation technologies that are practically in use and all existing products in the marketplace have remained dependent on the use of various types and concentrations of biologically reactive small molecule cryoprotectants that enter cells by permeation through the cell membranes (i.e., cell permeating). Cell permeating cryoprotectants are always required for cryostorage of all tissue types, as long as the goal of the practice of cryostorage is to maintain the viability and functionality of the majority of cells inside the tissues. Without permeating cryoprotectants, the tissues are mostly preserved for their genetic materials or pathological features only. The use of cell permeating small molecular cryoprotectants provide three major cryoprotective functions:

First, cell permeating small molecular cryoprotectants increase the viscosity of the cryoprotectant solutions. At relatively low concentrations, the viscous, cell permeating small molecular cryoprotectant liquids reduce the sizes of extracellular ice crystals formed during freezing, and at very high concentrations, prevent any ice formation i.e., a so-called vitrification approach.

Second, cell permeating small molecular cryoprotectants prevent intracellular ice formation. The viscous liquids enter the cell by permeation and thereby either reduce intracellular ice size to a degree that cell organelles remain undamaged, or completely prevent intracellular ice formation. Intracellular ice formation is generally believed to be introduced by large extracellular ice crystals that rupture damaged cell membranes.

Third, cell permeating small molecular cryoprotectants slow down cell-damaging recrystallization processes by increasing the viscosity of the solution. During storage at temperatures above the ice recrystallization range, e.g., greater than about −80° C., the aforementioned viscosity enhancement mechanism slows down the cell-damaging recrystallization process. The damaging mechanism is attributed to the physical properties of hexagonal ice crystals (i.e., Ice Ih, hexagonal crystal form of ordinary ice, or frozen water) at temperatures greater than about −100° C. Small, hexagonal ice crystals formed during freezing processes are thermally unstable and tend to either spontaneously combine and form larger ice crystals or simply continue to grow, thereby forming larger crystals, and thus damage to cells or tissues occurs during storage at about −80° C. (the typical working temperature of regular laboratory deep freezers) or during the thawing process.

To further improve the efficiency of these protection mechanisms, various types of non-permeating cryoprotectants have been utilized or developed for use in various cryopreservation methods. The additives include, but are not limited to: oligosaccharides, e.g., sucrose, raffinose and trehalose; polymers, e.g., hydroxyethyl starch (HES), polysaccharides, polyethylene glycol (PEG), polyvinylpyrrolidone (PVP), chondroitin sulfates, albumins, antifreeze proteins and some of their analogues; and natural or newly formulated biological compounds, e.g., human and animal serum and serum replacements. However, none of the existing cryoprotectants that include these components is capable of completely removing the need for a cell permeating cryoprotectant in the medium mixture in order to ensure post-thaw viability is achieved on a scale that is sufficient for practical cryopreservation uses for most cell types and all tissue types. In a report by Uchida et al (Uchida T, Takeya S. Powder X-ray diffraction observations of ice crystals formed from disaccharide solutions. Phys Chem Chem Phys. 2010 Dec. 7; 12(45):15034-9), when solutions with extremely high concentrations (approx. 50% w/v) of disaccharides (e.g., sucrose and trehalose) were frozen at a relatively high cooling rate (e.g., several hundred degrees per minute), then the saccharide molecules spontaneously precipitate due to their solubility limitations in water at low temperatures, and spontaneously form nano scale spherical particles (about 10-20 nm in size) to minimize the system's energy. Surrounding these saccharide particles, stable cubic ice (i.e., Ice I_{c}) crystalline of the size less than 10 nm, i.e., nano scale cubic ice, was identified. Different from hexagonal ice, cubic ice is a metastable cubic crystalline variant of ice that forms very small crystals, and can potentially increase cell viability during cryopreservation procedures by preventing mechanical damaged generated by the formation of relatively large (typically larger than 10 μm) hexagonal ice crystals. However, due to the requirement of the extremely high concentration of the disaccharides and fast cooling rates to form nano scale cubic ice using the method described above, such a procedure has never resulted in any practical application in cryopreservation.

There are few cell types that can be cryopreserved without cell permeating cryoprotectants. For example, red blood cells (lacking a nucleus and some organelles) can be cryopreserved with HES or analogy of anti-freeze protein; certain liver cell types, through active transport, are able to accumulate high concentrations of glucose inside cells and achieve relatively high post-thaw viabilities. Obviously, these specific features are not present in regular cell types, so the application of the associated methods is highly limited. Trehalose has been transported into various cell types through electroporation or acoustic methods to achieve cell cryopreservation without permeating cryoprotectants. However, these technologies are unsuitable for cryopreservation of any tissue type due to the limitation in transportation distance of the electric or acoustic fields. Meanwhile, in above methods, both trehalose and glucose molecules actually penetrate cell membranes, so these methods are still adopting so-called cell permeating approach. All these methods also require complicated operations to prevent extensive cell damages and expensive devices, and more importantly, require liquid nitrogen facilities for long-term storage.

Meanwhile, the use of non-permeating cryoprotectants as listed and described above do not efficiently mitigate the well-known negative impacts resulting from the use of permeating cryoprotectants. These negative impacts include:
Introduction of varying degrees of biochemical damage or complications including, but not limited to, toxicity, apoptosis, and unwanted differentiation of stem cells. Some of these effects generate regulatory concerns, especially in the development of cell-based therapy or regenerative medicine; and
Physical osmotic damage to cells and tissues during the loading procedure (i.e., prior to freezing) and also during the removal procedure (i.e., post-thaw), thereby damaging cell and tissue structures and ultra-structures.

Consequently, the above-described cryopreservation methods that utilize cell permeating cryoprotectants face unsolvable challenges for further improvement. Examples of these challenges are described in further detail below.

The vitrification approach using high concentrations, typically 40%-50% volume per volume (v/v) of cell permeating cryoprotectants, results in considerable chemical and osmotic impacts which are detrimental to therapeutic and tissue engineering applications, and which need to be reduced or totally eliminated. The vitrification approach also requires a cooling rate that is higher than the so-called critical cooling rate (for example, 104 Kelvin (K)/min) to achieve vitrification during cooling, and an even higher warming rate (for example 105 K/min) to prevent both devitrification (crystallization of vitrified solutions during warming) and any latter consequent recrystallization process of the devitrified solutions. Both requirements limit the sample size utilized in the vitrification approach due to the limitations of thermal conduction in biological samples. Moreover, due to the fact that the vitrification and devitrification temperatures of permeating cryoprotectant solutions are almost always lower than −100° C., vitrification procedures demand the use of cryogenic fluids (e.g., liquid nitrogen, −196° C. in the liquid phase and between about −120° C. and −196° C. in the vapor phase of a sealed container) and associated facilities, or very expensive ultra-low cryogenic freezers, instead of regular deep freezers that operate at about −80° C. However, liquid nitrogen facilities or devices are expensive and expansive, significantly increasing costs for storage, transportation, and maintenance. Thus, even if vitrification method can achieve high post-thaw viabilities, industrial users prefer to avoid this approach. With human skin allografts as an example, it has been demonstrated that small (e.g., less than 5 cm²) human skin samples can be efficiently cryopreserved using vitrification media and procedures, however, for storage of large numbers of regular donor tissues (each with size typically more than 100 cm²), skin banks use a traditional approach of freezing with 15%-30% v/v glycerol and storing in regular deep freezers, even though post-thaw viability is only about half of that obtained by vitrification methods.

The slow-cooling approach using a low concentration (typically 5-15% v/v) of a cell permeating cryoprotectant results in less chemical and osmotic damage than is obtained through a vitrification approach. Long-term storage in −80° C. freezers is possible for some mechanically robust cells (e.g., bacterial cells, certain insect cells, mammalian red blood cells) that are able to tolerate damage resulting from recrystallization. However, for a majority of mammalian cell types, long-term storage generally requires liquid nitrogen facilities unless recrystallization can be prevented. For tissues, slow-cooling methods generally result in poor post-thaw viability and severe structural tissue damage associated with ice formation during freezing and recrystallization during warming. Again, with human skin allografts as the example, the traditional glycerol derived approach results in over 50% cell loss in both laboratory-based, and tissue bank operations. The outcome is similar for other human tissue types.

A cryopreservation medium including highly compact spherical polysaccharide molecules such as Ficoll 70 (a spherical compact polysucrose molecule having a molecular weight (MW) approximating 70 k Da) at a relatively high concentration (about 10% w/v after mixing with cell suspensions) together with small concentration of DMSO (5-10% v/v) to prevent ice recrystallization at the storage temperature near −80° C., has been disclosed by Han et al., 2017 (Han X, Yuan Y, and Roberts R. M. 2017. Cryopreservation Medium and Method to Prevent Recrystallization, PCT/US2017/032606) and described by Yuan et al., 2016 (Yuan Y, Yang Y, Tian Y, Park J, Dai A, Roberts R M, Liu Y, Han X. Efficient long-term cryopreservation of pluripotent stem cells at −80° C. Nature, Scientific Reports. 2016 6:34476). This medium enabled low-term storage of mammalian cells in a regular deep freezer and thus removed the need for a liquid nitrogen facility for long-term storage of mammalian and insect cells, and also for tissue cryopreservation. As demonstrated by former thermal studies (Yuan Y, Yang Y, Tian Y, Park J, Dai A, Roberts R M, Liu Y, Han X. Efficient long-term cryopreservation of pluripotent stem cells at −80° C. Nature, Scientific Reports. 2016 6:34476), the medium containing 10% w/v to 20% w/v Ficoll 70 prevents ice recrystallization at the temperature up to about −65° C., so the method is suitable in long-term storage at any temperature below about −70° C., including the typical working temperatures of regular laboratory mechanical deep freezers. The commercialized product (C80EZ® medium) has been successfully used in numerous industrial applications, and continues to be used. However, use of Ficoll 70 alone, even at concentrations of greater than 20%, is still incapable of facilitating the complete removal of DMSO or other cell permeating cryoprotectants for efficient cell and tissue cryopreservation, as shown in one of our examples.

The present disclosure is directed to a cryopreservation media that combines the use of two types or classes of cryoprotective particles or macromolecules in an aqueous liquid, and removes the need for the use of a small molecule cell permeating cryoprotectant to achieve long-term storage of a biological samples while preserving preserve their cell viability and functionality. A “cryopreservation medium” is a solution that allows live cells (or components of cells or artificially created structure resembling cells or cell components) to be stored in a frozen state and to retain all or substantially all cellular properties and functions (or in the case of cellular components their respective properties) after thawing.

Disclosed herein is a cryopreservation medium comprising: a first cryoprotective particle or macromolecule; a second cryoprotective particle or macromolecule; and an aqueous liquid, wherein the first cryoprotective particle or macromolecule is hydrophilic and has a spherical shape when dissolved or suspended in the aqueous liquid, and wherein the second cryoprotective particle or macromolecule has an affinity for the first cryoprotective particle or macromolecule and an affinity for the plasma membrane of the cell.

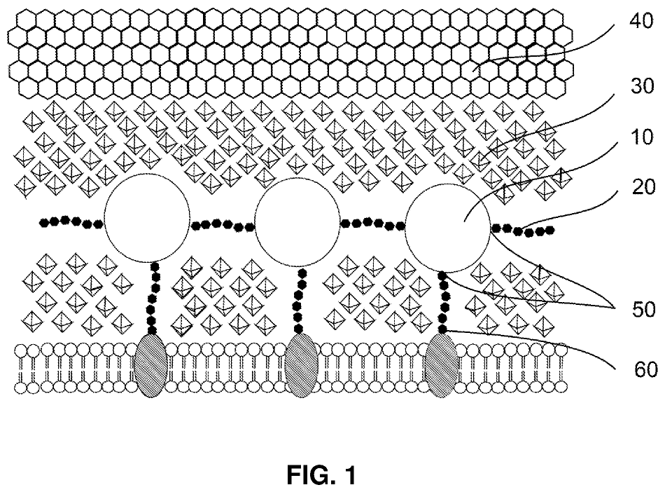

The first cryoprotective particle or macromolecule is hydrophilic and has the nano-scale features of being highly compact and spherical in shape, or nearly spherical, when dissolved or suspended in water, and also has a highly hydrophilic surface. In FIG. 1, a representative cryoprotective particle or macromolecule of the first type 10 is identified. In solution, the first cryoprotective particle or macromolecule promotes nano scale cubic ice crystal 30 formation near its surface, while also prevent preventing hexagonal ice crystal 40 formation near its surface.

The second cryoprotective particle or macromolecule possess high affinity for the first particle or macromolecule. In FIG. 1, a representative bond 50 is illustrated between the first and second cryoprotective particles or macromolecules.

Specific examples of the first cryoprotective particle or macromolecule include a spherical hydrophilic polysaccharide, a polymerized cyclodextrin, a polymerized saccharide, a globular protein, a spherical glycoprotein comprising oligosaccharide chains attached to an outer surface of a globular protein, a globular protein derivative, a globular polypeptide, a spherical nucleic acid, or a combination thereof.

The second cryoprotective particle or macromolecule also possesses a high affinity for structures/materials in the plasma membrane of a cell or cell-like structure, wherein such cell membranes are associated with the cell or tissue to be cryopreserved. Such structures/materials in the plasma membrane include, for example, the phospholipid layers, proteins or other macromolecules located on the outer surface of a cell plasma membrane. In FIG. 1, a representative bond 60 is illustrated between a cryoprotective particle or macromolecule of the second type and a cell membrane associated with the cell or tissue to be cryopreserved.

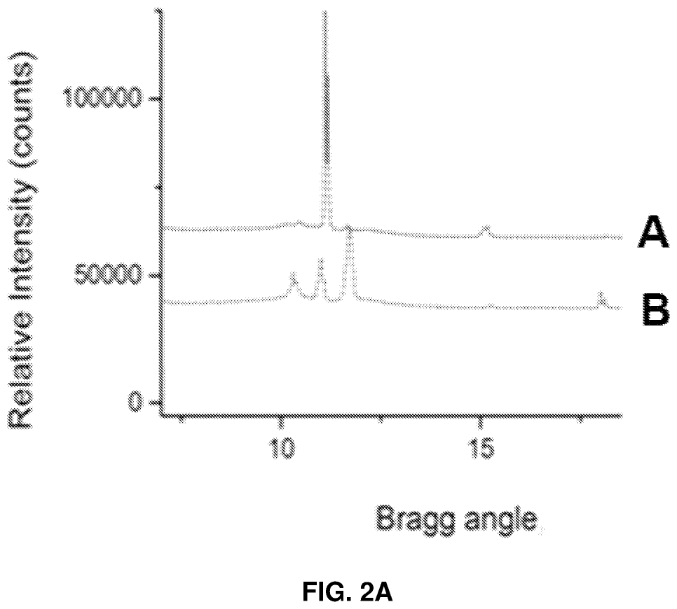

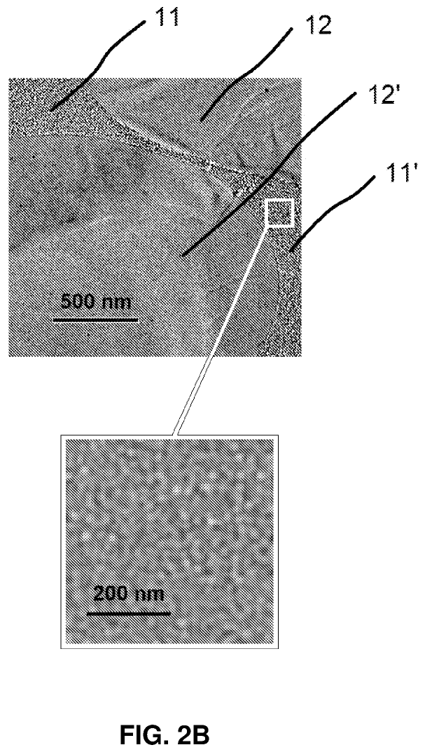

The above described and unique combination of bonding generated by use of the two types of cryoprotective particles or macromolecules acting together, significantly increases the probability that cell membranes contact only nano-scale cubic ice crystals that form near the surface of the first cryoprotective particle or macromolecule throughout the duration of the cryopreservation process. As demonstrated by the results of transmission electron microscopy shown in FIG. 2B, each of first particle or macromolecule can generate a layer of cubic ice of about 10-50 nm in thickness surrounding it after being cooled to about −80° C. As such, the cell plasma membrane is less prone to damage by large hexagonal ice crystals, as they are located a distance far away from the first cryoprotective particle or macromolecule due to the presence of the second cryoprotective particle or macromolecule in between. Consequently, the plasma membranes are well protected during freezing by this layer, and nano-scale ice formation outside of the membrane either does not introduce any intracellular ice formation, or the size and number of induced intracellular ice crystals in this scenario are much smaller than that of the nano-scale cubic ice crystals outside of the membrane. As such, intracellular components are also efficiently protected, even when there is no cell permeating cryoprotectant included in the cryopreservation medium.

The presence of the nano scale cubic ice structure and the first cryoprotective particle or macromolecule also separate and thus limits the direct contact of hexagonal ice crystals between each other, which prevents their combining or fusing to form larger crystals, and serves as a mechanism to prevent recrystallization of hexagonal ice. Such a mechanism of preventing recrystallization of hexagonal ice cannot be accomplished with traditional cryopreservation media containing small molecular cell permeating cryoprotectants or other types of non-permeating molecules. The nano scale cubic ice is the formation of Ice I_{c} to a scale of 0.1 nm to 10 nm in size.

As demonstrated in thermal studies by Yuan et al., 2016 (Yuan Y, Yang Y, Tian Y, Park J, Dai A, Roberts R M, Liu Y, Han X. Efficient long-term cryopreservation of pluripotent stem cells at −80° C. Nature, Scientific Reports. 2016 6:34476), the first cryoprotective particle or macromolecule prevents ice recrystallization at the temperature up to about −65° C. Therefore, the method of the present invention is suitable in long-term storage at any temperature below about −70° C., including the typical working temperatures of regular laboratory mechanical deep freezers, as well as storage temperatures of liquid nitrogen facilities (between about −120° C. and −196° C.) and lower temperatures (between −196° C. and −273° C.) provided by other cryogenic fluids or physical processes.

In an aspect, the first cryoprotective particle or macromolecule is a polymer. The polymer may comprise molecules that form the compact three-dimensional structures that are approximately spherical in shape when dissolved in the aqueous liquid. In an aspect, the first cryoprotective particle or macromolecule comprises a spherical hydrophilic polysaccharide, a polymerized cyclodextrin, a polymerized saccharide, a globular protein, a spherical glycoprotein comprising oligosaccharide chains attached to an outer surface of a globular protein, a globular protein derivative, or a combination thereof.

The first cryoprotective particle or macromolecule has a nanometer-sized particle diameter. In an aspect, the first cryoprotective particle or macromolecule has a particle size of about 50 nm or less, or about 25 nm or less, or about 10 nm or less. In an aspect, the first cryoprotective particle or macromolecule has a particle size of about 10 nm.

In an aspect, the first cryoprotective particle or macromolecule comprises a spherical hydrophilic polysaccharide comprising a copolymer of sucrose and epichlorohydrin. Examples of the copolymer of sucrose and epichlorohydrin include FICOLL™ molecules. The spherical hydrophilic polysaccharide can have an average molecular weight of about 50,000 Da to about 100,000 Da, or about 60,000 Da to about 80,000 Da, or about 68,000 Da to about 72,000 Da, or about 69,000 D1 to about 71,000 Da. In an aspect, the spherical hydrophilic polysaccharide has an average molecular weight of 70,000 Da. In another aspect, the spherical hydrophilic polysaccharide has an average molecular weight of about 5,000 Da to about 1,000,000 Da.

In an aspect, the first cryoprotective particle or macromolecule comprises FICOLL™ 70, also referred to herein generally as “Ficoll 70”, which is a high molecular weight sucrose polymer formed by copolymerization of sucrose and epichlorohydrin. Ficoll 70 molecules are highly branched and have a high content of hydroxyl groups, which leads to very good solubility of the material in aqueous media. Ficoll 70 has an average molecular weight of about 70,000 Da.

In an aspect, the second cryoprotective particle or macromolecule is also a polymer. The polymer may comprise molecules that are polysaccharides, and in particular, polysaccharides formed of chains of different types of sugars or a single type of sugar. In an aspect, the polysaccharides comprise a glycosaminoglycan (GAG), a modified GAG, a salt thereof, or a combination thereof. In an aspect, the GAG comprises chondroitin sulfate, dermatan sulfate, or a combination thereof. In an aspect, the chondroitin sulfate comprises chondroitin sulfate A, chondroitin sulfate C, chondroitin sulfate D, chondroitin sulfate E, a salt thereof, or a combination thereof. Examples of the modified GAG include, for example, sulfated GAG.

The salts disclosed herein are those that retain the biological effectiveness and properties of the given compound, and which are not biologically or otherwise undesirable. Acceptable base addition salts can be prepared from inorganic and organic bases. Salts derived from inorganic bases include, by way of example only, sodium, potassium, lithium, ammonium, calcium and magnesium salts. Salts derived from organic bases include, but are not limited to, salts of primary, secondary and tertiary amines, such as alkyl amines, dialkyl amines, trialkyl amines, substituted alkyl amines, di(substituted alkyl) amines, tri(substituted alkyl) amines, alkenyl amines, dialkenyl amines, trialkenyl amines, substituted alkenyl amines, di(substituted alkenyl) amines, tri(substituted alkenyl) amines, cycloalkyl amines, di(cycloalkyl) amines, tri(cycloalkyl) amines, substituted cycloalkyl amines, disubstituted cycloalkyl amine, trisubstituted cycloalkyl amines, cycloalkenyl amines, di(cycloalkenyl) amines, tri(cycloalkenyl) amines, substituted cycloalkenyl amines, disubstituted cycloalkenyl amine, trisubstituted cycloalkenyl amines, aryl amines, diaryl amines, triaryl amines, heteroaryl amines, diheteroaryl amines, triheteroaryl amines, heterocyclic amines, diheterocyclic amines, triheterocyclic amines, mixed di- and tri-amines where at least two of the substituents on the amine are different and are selected from the group consisting of alkyl, substituted alkyl, alkenyl, substituted alkenyl, cycloalkyl, substituted cycloalkyl, cycloalkenyl, substituted cycloalkenyl, aryl, heteroaryl, heterocyclic, and the like. Also included are amines where the two or three substituents, together with the amino nitrogen, form a heterocyclic or heteroaryl group.

Examples of pharmaceutically acceptable salts include, but are not limited to, mineral or organic acid salts of basic residues such as amines; alkali or organic salts of acidic residues such as carboxylic acids; and the like. The pharmaceutically acceptable salts include the conventional non-toxic salts and the quaternary ammonium salts of the parent compound formed, for example, from non-toxic inorganic or organic acids. For example, conventional non-toxic acid salts include those derived from inorganic acids such as hydrochloric, hydrobromic, sulfuric, sulfamic, phosphoric, nitric and the like; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, mesylic, esylic, besylic, sulfanilic, 2-acetoxybenzoic, fumaric, toluenesulfonic, methanesulfonic, ethane disulfonic, oxalic, isethionic, HOOC—(CH2)n-COOH where n is 0-4, and the like.

In an aspect, the second cryoprotective particle or macromolecule comprises chondroitin sulfate A sodium salt.

The cryoprotective medium disclosed herein includes an aqueous liquid. An “aqueous liquid” is a liquid that primarily includes water and is in a liquid state over a range of temperatures at which water is in a liquid state. In an aspect, the aqueous liquid comprises a salt solution, a cell or tissue culture medium, a buffer or a combination thereof.

The salt solution includes, such as for example, Alsever's solution, Earle's balanced salt solution (EBSS), Gey's balanced salt solution (GBSS), Hank's balanced salt solution (HBSS), (Dulbecco's) phosphate buffered saline (DPBS or PBS), Ringer's balanced salt solution (RBSS), Simm's balanced salt solution (SBSS), TRIS-buffered saline (TBS), Tyrode's balanced salt solution (TBSS), HEPES (4-(2-hydroxyethyl)-piperazin-1-yl]ethane-1-sulfonic acid), CaCl₂) aqueous solution, NaCl aqueous solution, KCl aqueous solution, or a combination thereof.

In an aspect, the aqueous liquid may comprise a cell or tissue culture medium. The cell or tissue culture medium includes components which facilitate growth and/or maintenance of cells and/or tissues. The specific composition of the cell or tissue culture medium varies depending upon the type of cell and/tissue with which it is used. Non-limiting examples of components in the cell or tissue culture medium include, for example, serum (e.g., fetal bovine serum; FBS), carbohydrates (e.g., sucrose, galactose, fructose, maltose), amino acids, vitamins, minerals, inorganic salts, pH buffer system, hormones, basic and trace elements (iron, zinc, copper, selenium, magnesium), supplements, antibiotics. Specific examples of cell or tissue culture medium, which can be used alone or in combination with additional components (e.g., serum, antibiotics, etc.), include Dulbecco's Modified Eagle Medium (DMEM), Iscove's Modified Dulbecco's Medium (IMDM), flushing/holding medium (FHM), DPBS (Dulbecco's phosphate-buffered saline), RPMI (Roswell Park Memorial Institute) medium, BF5 medium, EX-CELL® medium, Lysogeny broth (LB), or a combination thereof.

An amount of the first cryoprotective particle or macromolecule in the cryopreservation medium is about 10% (w/v) to about 50% (w/v), or about 15% (w/v) to about 30% (w/v), or about 15% (w/v) to about 25% (w/v), or about 18% (w/v) to about 22% (w/v).

An amount of the second cryoprotective particle or macromolecule in the cryopreservation medium is about 1% (w/v) to about 15% (w/v), or about 2.5% (w/V) to about 10% (w/v), or about 4.5% (w/v) to about 10% (w/v), or about 4.5% (w/v) to about 7.5% (w/v).

The present disclosure provides a method for cryopreserving cells and tissues using the cryopreservation medium disclosed herein. In an aspect, the cryopreservation medium substantially no cell permeating cryoprotectant. Put another way, the cryopreservation medium is substantially free of cell permeating cryoprotectant. As used herein “substantially free of cell permeating cryoprotectant” and/or “substantially no cell permeating cryoprotectant” means that the cryopreservation medium contains less than 5%, or less than 2.5%, or less than 1%, or less than 0.5% of a cell permeating cryoprotectant. In an aspect, the cryopreservation medium is free of cell permeating cryoprotectant i.e., does not include any cell permeating cryoprotectant.

The cryopreservation medium can be used for the protection of a lipid membrane of a lipid membrane bound biological structure. As used herein “lipid membrane bound biological structure” refers to a biological structure having a lipid membrane which defines the outer surface of the biological structure. Such lipid membrane bound biological structures includes a cell, an extracellular vesicle, and/or a lipid bound vesicle. A “tissue,” which is a structure comprised of at least one cell having an outer surface defined by a lipid membrane, is also encompassed by the term. Accordingly, in an aspect, the lipid membrane bound biological structure comprises a cell, a tissue, an extracellular vesicle, a lipid bound vesicle, an organ, an organism, or a combination thereof.

In an aspect, the lipid membrane bound biological structure comprises a cell, an extracellular vesicle, a lipid bound vesicle, an organ, an organism, or a combination thereof.

In an aspect, the lipid membrane bound biological structure is a tissue comprising a plurality of cells, an organ comprising a plurality of cells, or an organism comprising a plurality of cells.

In an aspect, disclosed herein is a method of protecting a lipid membrane of a lipid membrane bound biological structure comprising, contacting the lipid membrane bound biological structure with a cryopreservation medium prior to cooling the lipid membrane bound biological structure to a temperature between about −70° C. and about −273° C., wherein cubic ice is formed around the lipid membrane at the temperature between about −70° C. and about −273° C.

Also disclosed is a method for cryopreservation of a lipid membrane bound biological structure, comprising: contacting the lipid membrane bound biological structure with the cryopreservation medium disclosed herein to treat the lipid membrane bound biological structure; cooling the treated lipid membrane bound biological structure to a temperature between about −70° C. and about −273° C. to freeze the lipid membrane bound biological structure; and maintaining the frozen lipid membrane bound biological structure at the temperature between about −70° C. and about −273° C.

In an aspect, the contacting comprises adding an amount of the cryopreservation medium to a two-dimensional or three-dimensional culture comprising the lipid membrane bound biological structure and a culture medium. The cryopreservation medium can be added directly to the lipid membrane bound biological structure in the two-dimensional or three-dimensional culture without removal of the culture medium. In an aspect, the culture medium can be removed prior to adding the cryopreservation medium.

In an aspect, a concentrated preparation of the cryopreservation medium is added directly to a culture or suspension including the lipid membrane bound biological structures without first removing the culture medium (or a wash medium if the lipid membrane bound biological structures have been washed). The concentrated cryopreservation medium comprises increased amounts of the first and second particles or macromolecules such that the concentration of the first and second particles or macromolecules is about 1.5 fold, or about 2 fold, or about 2.5 fold, or about 3 fold, or about 3.5 fold, or about 4 fold, or about 4.5 fold, or about 5.5 fold, or about 6 fold, or about 6.5 fold, or about 7 fold, or about 7.5 fold, or about 8 fold, or about 8.5 fold, or about 9 fold, or about 9.5 fold, or about 10 fold greater than their respective concentrations in the unconcentrated cryopreservation medium, i.e., as described above. The concentrated cryopreservation medium is added at a certain volume ratio in order to dilute the concentration of the first and second the particles or macromolecules in the medium to the above-described amounts.

In an aspect, the lipid membrane bound biological structures are in suspension and are pelleted (for example, by centrifugation) prior to contacting the lipid membrane bound biological structures with preservation medium. Once pelleted, any culture medium or wash medium present is removed from the lipid membrane bound biological structures and the cryopreservation medium is directly added to the pellet to resuspend the lipid membrane bound biological structures, and the new suspension is then cooled to cryogenic temperatures for storage. In an aspect, the volume ratio of the cryopreservation medium to the pellet of lipid membrane bound biological structures is 10:1 to about 10,000:1.

In an aspect, for the volume ratio of the cryopreservation medium to tissues or other membrane bound biological structures of relatively large volume, about 1:1 to about 10:1.

In an aspect, the lipid membrane bound biological structures to be cryopreserved are contacted with the cryopreservation medium for a time period that is sufficient to allow a thorough diffusion of the first and second particles or macromolecules present in the medium, by the lipid membrane bound biological structures. The thus-treated lipid membrane bound biological structures are then cooled to cryogenic temperatures for storage.

In an aspect, the treated lipid membrane bound biological structures are cooled to a temperature of between about −70° C. and about −273° C. to freeze the lipid membrane bound biological structures. In an aspect, the treated lipid membrane bound biological structures are cooled to a temperature of about −196° C. to about −70° C., or about −120° C. to about −80° C., to freeze the lipid membrane bound biological structures. In an aspect, the cryopreservation medium and the lipid membrane bound biological structures are contacted at room temperature for a period of about 30 minutes to about 120 minutes prior to the cooling.

In some embodiments, the cooled occurs at a rate of about 0.01° C./min to about 1000° C./min, or at a rate of about 0.1° C./min to about 100° C./min, or at a rate of about 0.5° C./min to about 1° C./min, or at a rate of about 1° C./min to about 5° C./min. In some aspects, the cooling is performed directly after contacting the lipid bound biological structure with the cryopreservation medium.

Optionally, prior to the cooling step, the lipid membrane bound biological structures can first be frozen at a temperature of about −18° C. to about −25° C. for a period of time. The time period is long enough to ensure thorough freezing of the lipid membrane bound biological structures or relatively large sizes, but not so long as to detrimentally affect their structure and/or viability. The time period can be from about 6 hours or about 12 hours to 1 week or longer, but is not necessarily limited.

In the methods disclosed herein, following cooling, the lipid membrane bound biological structures are maintained (stored) at the temperature of between about −70° C. and about −273° C.

As discussed above, during cooling water in the cryopreservation medium forms cubic ice at an outer surface of the lipid membrane of the lipid membrane bound biological structures. Accordingly, the frozen lipid membrane bound biological structures remain substantially intact when maintained at the temperature of about −70° C. to about −85° C. for a time period of at least three weeks. In an aspect, the time period is at least one year.

In an aspect, the lipid membrane bound biological structure comprises a plurality of cells, and a post-thaw survival rate of the frozen plurality of cells is greater than or equal to about 60%, or about 75%, or about 80%, or about 90%, of the total number of viable cells prior to the cooling.

In an aspect, the lipid membrane bound biological structures comprise eukaryotic or prokaryotic cells. The eukaryotic cells may be mammalian cells, plant cells, insect cells, or a combination thereof. The mammalian cells are not necessarily limited and include, for example, human cells, murine cells, porcine cells, bovine cells, canine cells, feline cells, or a combination thereof. The mammalian cells include stem cells, adipose cells, somatic cells, reproductive cells, chromaffin cells, dermal cells, epithelial cells, neural progenitor cells, embryonic stem cells, pluripotent stem cells, red blood cells, white blood cells, or a combination thereof.

In an aspect, the lipid membrane bound biological structure comprises a tissue. The tissue is a biological or bioartificial eukaryotic tissue. The eukaryotic tissue may be a mammalian tissue. The mammalian tissues include, for example, human tissues, murine tissues, porcine tissues, bovine tissues, canine tissues, feline tissues, or a combination thereof, but are not limited thereof.

In an aspect, the viability of the frozen tissue post-thaw is greater than viability of a same frozen tissue that has been contacted with a cryopreservation medium including a cell permeating cryoprotectant.

The present disclosure combines the use of highly compact spherical and highly hydrophilic Ficoll 70 and chondroitin sulfate. Their combined use fundamentally changes the ice formation mechanism on both nanoscale and cellular levels, with the hypothetically essential physical and biophysical working mechanism, as illustrated in FIG. 1.

As shown in FIG. 1, each first cryoprotective particle or macromolecule 10 (e.g., Ficoll 70) promotes nano-scale cubic ice 30 formation near its surface. The first cryoprotective particle or macromolecule 10 possesses a combination of unique features such as having a nearly perfect spherical shape and a nanometer-sized particle diameter (e.g., particle size (diameter) of about 10 nm) and being highly compact and highly hydrophilic, and results in nano-scale cubic ice structures. To our knowledge, such nano-scale cubic ice structures are absent in all other existing cryoprotectant media that use any other polymer types.

The second cryoprotective particle or macromolecule 20 (e.g., chondroitin sulfate acts as a “glue” or “connector” that not only improves the connections between the plasma membranes of the cell and the first cryoprotective particles or macromolecules 10, but also between the first cryoprotective particles or macromolecules themselves, thereby forming a special network composed of the cell plasma membranes and the first cryoprotective particles or macromolecules near the surface of the cells. This unique combination and use of the first and second cryoprotective particles or macromolecules, together significantly increases the probability that cell membranes contact only nano-scale cubic ice crystals that form near the surface of the first cryoprotective particle or macromolecule. As such, the cell plasma membrane is less apt to becoming damaged by large hexagonal ice crystals 40 that are located a distance far from a surface of the first cryoprotective particle or macromolecule 10. Consequently, the plasma membranes are well protected during freezing, and the nano-scale ice formation outside of the membrane either does not introduce any intracellular ice formation, or the size and number of induced intracellular ice crystals is much less than the size and number of the nano-scale cubic ice crystals outside of the membrane. As such, intracellular components are also efficiently protected.

The working mechanism of the combinative use of the first and second cryoprotective particles or macromolecules, using Ficoll 70 and chondroitin sulfate molecules as specific examples, is explained in further detail below.

As a significant difference from other macromolecules used for cryopreservation, Ficoll 70 in an aqueous solution forms a nearly perfect spherical shape with a highly compact structure. It has been advantageously discovered that the special structure and highly hydrophilic surface that Ficoll 70 possesses (i.e., a highly branched sucrose network) promotes nanoscale cubic ice formation during freezing.

According to the phase diagram for pure water, at 1 atm, cubic ice forms only at temperatures lower than −100° C. At pressures significantly lower than 1 atm, water can form cubic ice at temperatures greater than −100° C. If Ficoll 70 macromolecules are present in the water, nano scale cubic ice formation can be achieved at relatively high temperatures (e.g., above −80° C.) near the surface of Ficoll 70 molecules. This effect has been proved by results obtained from experiments using cryogenic X-ray diffraction and transmission electron microscopy of the replica of the freeze-fractured sample of the medium containing 10% Ficoll 70, as shown in FIGS. 2A and 2B.

In a report by Uchida et al., 2010 (Uchida T, Takeya S. Powder X-ray diffraction observations of ice crystals formed from disaccharide solutions. Phys Chem Chem Phys. 2010 Dec. 7; 12(45):15034-9), when solutions with extremely high concentrations (approx. 50% w/v) of disaccharides (e.g., sucrose and trehalose) were frozen at a relatively high cooling rate (e.g., several hundred degrees per minute), then the saccharide molecules spontaneously precipitate due to their solubility limitations in water at low temperatures, and spontaneously form nano scale spherical particles to minimize the system's energy. The X-ray diffraction patterns similar to that of the Ficoll rich medium, as shown in FIG. 2A, were then discovered in those frozen solutions having the nano scale granulated saccharide particles. However, if these same solutions were cooled at a slower cooling rate (e.g., one degree per minute, as is employed for cell and tissue slow freezing procedures), than those nano scale spherical structures were not formed, and instead only regular hexagonal ice formation was detected in the same solutions. Using such high concentrations of small molecular saccharides also caused lethal osmotic damages to nearly all cell types, which is not a practical cryopreservation approach.

Meanwhile, cubic ice has been predicted to form in certain nano-structures (Davies M B, Fitzner M, Michaelides A. Routes to cubic ice through heterogeneous nucleation. Proc Natl Acad Sci USA. 2021 Mar. 30; 118(13):e2025245118). However, due to multiple impacting factors, such as the surface of normal materials (e.g., proteins having semi-spherical shapes) being irregular on a nano-scale, and/or those molecules are relatively loose and not as compact as Ficoll 70 molecules, and/or the surface is not as hydrophilic as Ficoll 70, and/or the solubility is very low, the resulting ice structure is generally hybrid, or the cubic ice portion is too minimal due to the low solubility of the associated particles or macromolecules. Therefore, what has been advantageously discovered by the compositions of the medium of the present invention and methods is a unique ice formation mechanism generated by Ficoll 70 molecules.

Without being limited by theory it is possible that other artificial spherical nanoparticles (e.g., highly spherical organic or inorganic nanoparticles) with or without certain surface modification (e.g., binding with saccharide molecules), may also achieve similar effects as Ficoll 70 if their hydrophilicity and solubility are sufficiently high. Highly compact, spherical polysaccharide molecules (e.g., poly-trehalose and poly-mannitol) may also be able to achieve similar effects. For existing polysaccharides, nearly all types form a loose structure when being solved in water or in irregular shapes, the exception being dextran of various molecular weights, which forms a long-rod structure that is unsuitable for promoting predominant cubic ice formation. Meanwhile, Ficoll 400 (polysucrose with MW about 400 k Da), as an example of another highly compact and spherical polysucrose type, has a much larger diameter than Ficoll 70, which results in a lessened surface tension and is thus less efficient.

However, the nano scale cubic ice formation phenomena described above is localized near the Ficoll 70 surface, and the hexagonal ice formed a distance relatively far away from the surface of the Ficoll 70 molecules, still dominates in frozen Ficoll 70 solutions, and the dominating TE111 peak (typical for cubic ice) observed by X-ray diffraction of the frozen Ficoll 70 solutions, as shown in FIG. 2A, is due mainly to the fact that cubic ice generates a stronger diffraction intensity that is comparable to the X-ray wavelength due to its nano scale crystal size. Therefore, the use of Ficoll 70 alone is insufficient, and cells suspended in Ficoll 70 solutions have a high probability for being damaged by hexanol ice.

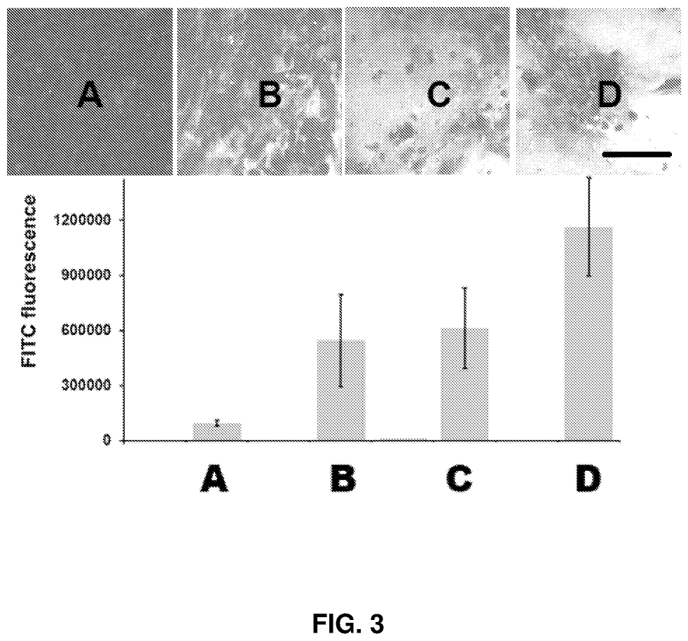

Chondroitin sulfates have a high affinity for cell membranes and significantly increase the adherence between cell membranes and other organic materials. Chondroitin sulfates have also been frequently used in tissue engineering to promote cell adherence to tissue scaffolds. Chondroitin sulfates, with their repeating disaccharide units, also possess a natural affinity with Ficoll 70 which has a surface formed by a highly branched sucrose network. Therefore, the addition of a sufficient concentration of a chondroitin sulfate in Ficoll 70 aqueous solutions significantly increases the opportunity and probability for cell membranes to bind to Ficoll 70 molecules, and simultaneously for Ficoll molecules to bind to each other and thereby form a network, as illustrated in FIG. 1. Results shown in FIG. 3 using fluorescence microscopy support this novel mechanism of action.

Consequently, during freezing, this newly discovered working mechanism efficiently prevents any hexagonal ice formation near a cell membrane in close proximity to a Ficoll 70 macromolecule. Meanwhile, since intracellular ice is generally introduced by extracellular ice, and the size of intracellular ice crystals is always much smaller than that of extracellular ice crystals, then due to the presence of high concentration of intracellular macromolecules (approx. 30%-50% v/v in mammalian cells before freezing, which will be significantly increased due to the loss of intracellular water during freezing), the nano-scale cubic ice formation near the cell membrane serves to thwart intracellular ice formation. Even if any induced intracellular ice forms in this scenario, then the size of such crystalline ice would be much smaller than that of the nano-scale ice structures outside of the cell membrane and cause no, or negligible, damage to intracellular organelles or cell ultrastructure. As such, the combined use of both Ficoll 70 and chondroitin sulfate, in sufficient concentrations in an aqueous media, provide suitable protection to both the cell membrane and intracellular structures, thereby enhancing post-thaw viability.

It is also believed that the efficiency of such cryopreservation media may be also due to several other beneficial factors which are contributed specifically by the presence of chondroitin sulfates. These factors, include but are not limited to, the role of chondroitin sulfate as an anti-apoptotic agent in reducing cell death due to certain biophysical impacts (e.g., loss of intracellular water during freezing); the role of chondroitin sulfate in stimulating the cellular syntheses of proteoglycans and hyaluronic acid that in turn stimulate proper structure and function towards thereby reducing freezing damage; and/or the role of chondroitin n slowing down damaging processes in cells through various mechanisms.

This disclosure is further illustrated by the following examples, which are non-limiting.

### EXAMPLES

Example 1: Detection of nano scale cubic ice in the medium containing Ficoll 70, through cryogenic X-ray diffraction and transmission electron microscopy of the replica of the freeze-fractured samples

The formation of nano scale cubic ice in the media containing relatively high concentration of Ficoll 70, as a unique cryoprotective mechanism, is demonstrated by the results of both cryogenic X-ray diffraction and transmission electron microscopy.

A standard sample holder containing a solution of 10% Ficoll 70 in water was slowly frozen to −80° C. first and then examined in a cryogenic X-ray diffraction chamber, following the protocol described by Holm et al., 2004 (Holm A P, Pecharsky V K, Gschneidner K A, Rink R, and Jirmanus M N, X-ray powder diffractometer for in situ structural studies in magnetic fields from 0 to 35 kOe between 2.2 and 315 K, Rev. Sci. Instrum. 2004 75:1081) and by using the same device system. As shown in FIG. 2A, the detection of the X-ray diffraction (line A) at −80° C. demonstrated a dominant TE111 peak that is characteristic of cubic ice formation, and the size of cubic ice crystals generates a strong diffraction intensity that is comparable to the X-ray wavelength due to their nano scale crystal size. In contrast, for solutions of 10% DMSO in water, or 10% DMSO plus 10% PVP or PEG in water, the diffraction pattern (line B) following the same procedure was almost the same, as that from regular hexagonal ice and without a dominant TE111 peak.

A standard sample holder for freeze fracture containing a solution 10% Ficoll 70 in water was slowly frozen to −80° C. first, and then transferred to a standard freeze-fracture replica sample preparation system (Leica E M ACE900). A replica of the fractured surface was produced using gold and nickel nanoparticles. The replica was then analyzed using a regular transmission electron microscope. At the amplification of 10,000×, the structure of the hexagonal ice crystals (12 and 12′ in FIG. 2B) that are separated by a mixture (11 and 11′ in FIG. 2B) of Ficoll molecule and nano scale ice was clearly revealed. And the further amplification in 11 or 11′ demonstrated the Ficoll molecules are surround by finer ice structure, which is cubic ice determined from the results of the X-ray diffraction experiments shown in FIG. 2A.

These studies explained the unique working mechanism of Ficoll 70 molecules in forming cubic ice near their surface at a temperature above −100° C. at 1 atm, which is physically impossible for regular aqueous solutions, and that Ficoll 70 medium prevent hexagonal ice recrystallization by separating them from each other, explain the mechanism underlying the thermal studies demonstrated by Han et al., 2017 (Han X, Yuan Y, and Roberts R. M. 2017. Cryopreservation Medium and Method to Prevent Recrystallization, PCT/US2017/032606) and Yuan et al., 2016 (Yuan Y, Yang Y, Tian Y, Park J, Dai A, Roberts R M, Liu Y, Han X. Efficient long-term cryopreservation of pluripotent stem cells at −80° C. Nature, Scientific Reports. 2016 6:34476).

Example 2: Fluorescence microscopy demonstrating that the chondroitin sulfate A sodium salt molecules significantly promote the affinity between the Ficoll 70 molecules and cell membranes

The addition of sufficient concentrations of chondroitin sulfate into Ficoll 70 aqueous solutions (DMEM) increases the opportunity for and probability of cell membranes to bind to Ficoll 70 molecules, and simultaneously for Ficoll molecules to bind to each other and thereby form a network. A fluorescence microscopic experiment was performed to demonstrate this unique mechanism.

The fluorescein isothiocyanate form of Ficoll 70 (FITC-Ficoll 70) was purchased. Retinal pigment epithelial (RPE) cell sheets were combined with four different solutions based on DMEM media, including the following: (A) 20% w/v regular Ficoll 70, (B) 20% Ficoll+0.01% FITC-Ficoll, (C) 20% Ficoll+0.01% FITC-Ficoll+2.5% chondroitin sulfate A sodium salt, and (D) 20% Ficoll+0.01% FITC-Ficoll+5% chondroitin sulfate A sodium salt. The FITC fluorescence intensity was measured near the surface of the cell sheet, and the results are shown in FIG. 3.

As can be seen in FIG. 3, after only a short period of time (15 min), the solutions containing 5% chondroitin sulfate significantly promoted the attachment of FITC-Ficoll to the cell surface. This experiment thus elucidated the working mechanism of the cryopreservation medium and tested the hypothesis illustrated in FIG. 1. Consequently, during freezing, this newly discovered working mechanism efficiently prevents regular hexagonal ice formation near a cell membrane in close proximity to a Ficoll 70 macromolecule. Meanwhile, since intracellular ice is generally introduced by extracellular ice, and the size of intracellular ice crystals is always much smaller than that of extracellular ice crystals, then due to the presence of high concentration of intracellular macromolecules (approx. 30%-50% v/v in mammalian cells before freezing, that will be significantly increased due to the loss of intracellular water during freezing), the nano-scale cubic ice formation near the cell membrane should serve to thwart intracellular ice formation. As such, the combinative use of both Ficoll 70 and chondroitin sulfates in an aqueous media is able to provide sufficient protection to both cell membrane and intracellular structures, and thus enhance post-thaw viabilities.

Example 3: Cryomicroscopy demonstrating that the medium of the present invention prevents intracellular ice formation during freezing

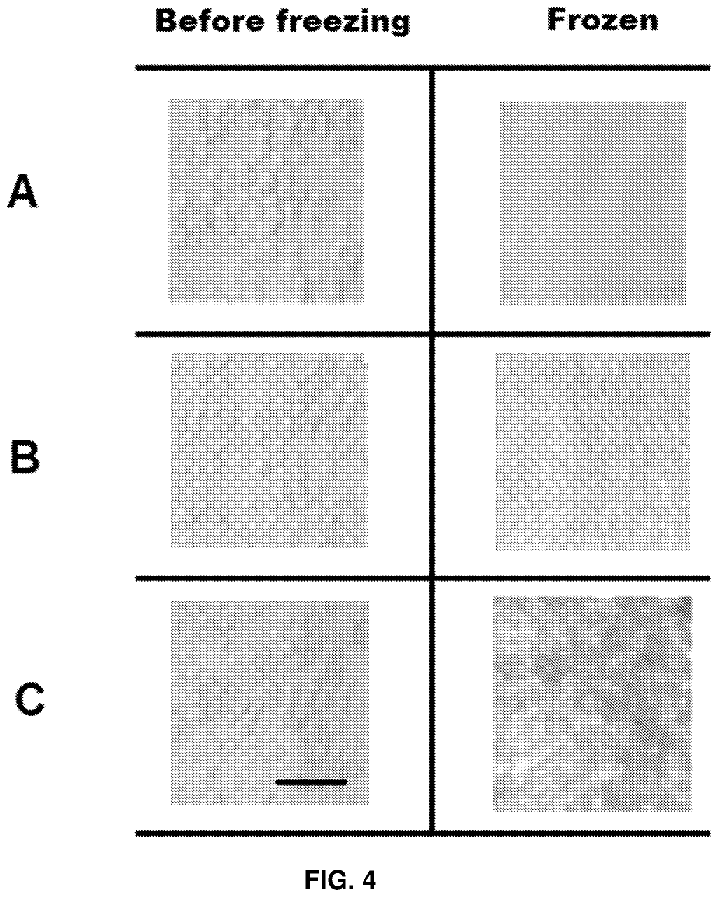

Sf9 cells (a standard insect cell line) with a cell density of 10⁸ cells/ml (the total volume of cells vs., that of the medium is about 1:2) were suspended in its regular culture medium EX-CELL medium containing 20% w/v Ficoll 70 and 5% chondroitin sulfate A sodium salt (A), the EX-CELL medium containing 10% v/v DMSO and 10% v/v FBS (B), and EX-CELL alone (C), respectively. The cell suspension samples were loaded in the freezing chamber of a standard cryomicroscope (Linkam, UK) and cooled from 0° C. to −196° C. at a cooling rate of 1 K/min. As demonstrated in FIG. 4, the medium of the present invention (A), as well as the regular cryopreservation medium (B), both prevent intracellular ice formation, which is typically much darker than that of extracellular ice region in the view of cryomicroscopy, while the procedure resulted in severe intracellular ice when the culture medium has no cryoprotectants (C). The ice crystals in the A are also much smaller than in B, for the medium of invention significantly reduced the hexagonal ice crystal size through the mechanism illustrated in Example 2.

Example 4: The efficacy of the medium of the present invention in cryopreservation of Sf9 cells at both −80° C. and liquid nitrogen temperatures.

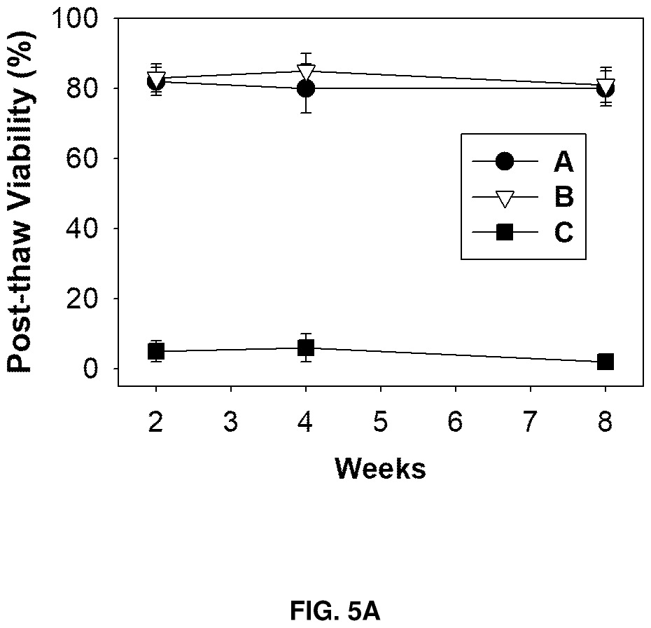

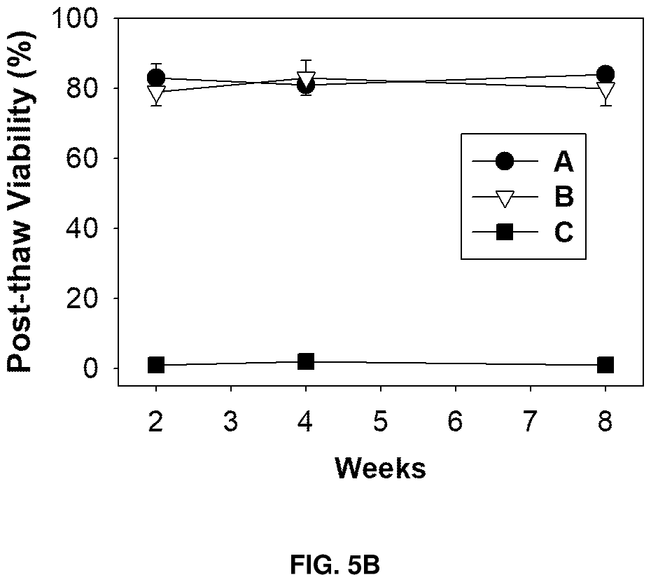

The cell suspensions of Example 3 were also transferred to cryovials and frozen at −80° C. in a regular lab deep freezer or a liquid nitrogen tank for storage after 2, 4 and 8 weeks. The treatments were the EX-CELL medium containing 20% w/v Ficoll 70 and 5% chondroitin sulfate A sodium salt (A), the EX-CELL medium containing 10% v/v DMSO and 10% v/v FBS (B) and EX-CELL alone (C). The results of the post-thaw viability measured by a standard automated cell counter (Countess II) and Trypan blue assay are shown in FIG. 5 for storage at −80° C. (FIG. 5A) and liquid nitrogen temperatures (FIG. 5B). Obviously, for Sf9 cells, the medium of the invention achieved similar efficiency as that using regular cryopreservation media in both storage conditions, while negligible cell survival was observed from using media containing no cryoprotectants. Using traditional methods, Sf9 cells can be cryopreserved at −80° C. for long-term, but most other cells and all tissues cannot, as demonstrated in the following examples.

Example 5: The efficacy of the cryopreservation medium of the present invention in cryopreservation of human adipose stem cells at −80° C.

The long-term storage of human adipose derived mesenchymal stem cells at −80° C. in cryoprotection medium containing 20% w/v Ficoll 70 and 5% w/v chondroitin sulfate A sodium salt, was compared to traditional medium containing 10% DMSO and 10% fetal bovine serum.

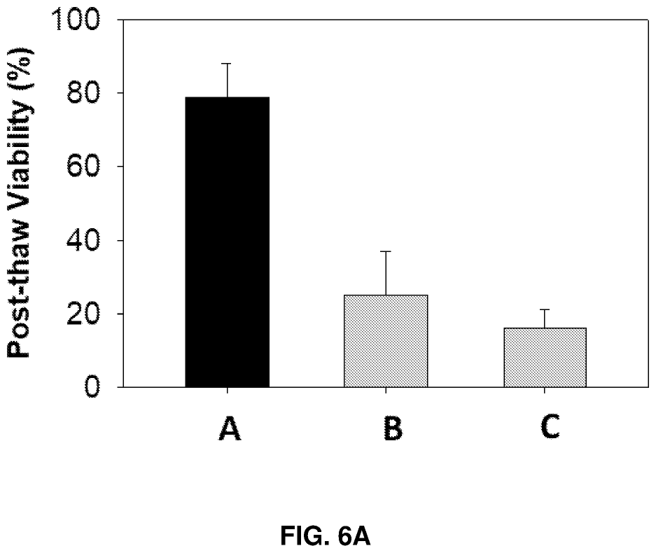

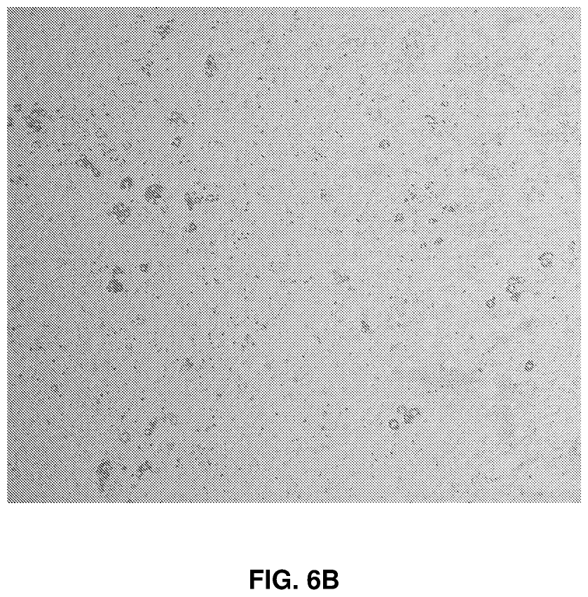

Human adipose derived mesenchymal stem cells (hASC) from donors were passaged to yield sufficient numbers of plated cell culture flasks following standard culturing protocols for hASCs. The cells were transferred to centrifuge tubes to form cell pellets by centrifugation, and the supernatant was removed. The cryopreservation medium, including 20% w/v Ficoll 70 and 5% w/v chondroitin sulfate A sodium in Dulbecco's Modified Eagle's (DMEM) medium, and without any cell permeating cryoprotectant, was directly added to the cell pellets to form new suspensions having a cell density of approximately 10⁶ cells/ml (the total volume of the cells vs. that of the medium is about 1:200). The new suspensions were aliquoted into standard cryovials. The cryovials were then cooled to −80° C. in a regular laboratory deep freezer using a standard cooling box at a cooling rate of approximately 1° C./min and stored in the −80° C. freezer for two months. The cryovials were thawed in a 37° C. water bath and post-thaw viabilities were determined using a standard automated cell counting device based on Trypan Blue exclusion. As a comparison, cells from the same donors were also prepared using the traditional cryopreservation medium of the standard culture medium containing 10% v/v DMSO and 10% v/v fetal bovine serum, or using DMEM with 20% w/v Ficoll 70 alone. The significantly improved post-thaw viability obtained using the cryopreservation medium of the present invention is demonstrated in FIG. 6A (the black bar).

As shown in FIG. 6A, greater than 80% survival was observed when the cryoprotection medium containing 20% w/v Ficoll 70 and 5% w/v chondroitin sulfate A sodium salt was used. In comparison, there was only about 20% survival using the traditional medium containing 10% DMSO and 10% fetal bovine serum, and only about 20% survival using 20% w/v Ficoll 70 alone. See FIG. 6A.

The thawed cells from the treatment using the cryoprotection medium also proliferated efficiently and expressed adipogenesis as shown in FIG. 6B. Therefore, the cryoprotection medium containing 20% w/v Ficoll 70 and 5% w/v chondroitin sulfate A sodium salt efficiently enables long-term storage of hASC at −80° C. and preserves the cell viability and multipotency. Although traditional media containing 10% DMSO and serum enabled similar efficiency for long-term storage in a liquid nitrogen facility, such an approach is not suitable for −80° C. storage, due to the cell damaging recrystallization which occurs, as explained herein.

Example 6: The efficacy of the cryopreservation medium of the present invention in cryopreservation of bovine chromaffin cells at −80° C.

Efficient long-term storage at −80° C. of bovine primary chromaffin cells using cryopreservation medium containing 20% w/v Ficoll 70 and either 5% or 10% w/v chondroitin sulfate A sodium salt was compared to traditional medium containing 10% DMSO and 10% fetal bovine serum.

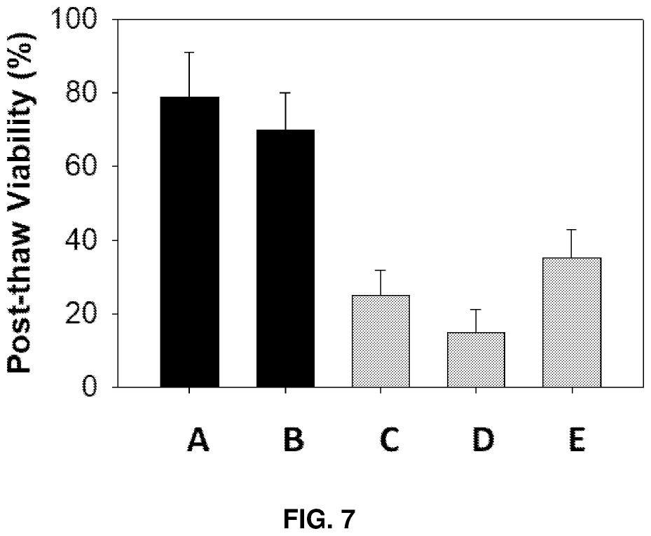

Bovine primary chromaffin cells were isolated from bovine adrenal glands. Using the same procedures as described in Example 1, the cells were preserved as follows: (A) DMEM with 20% w/v Ficoll 70 and 5% chondroitin sulfate A sodium salt; (B) DMEM with 20% w/v Ficoll 70 and 10% w/v chondroitin sulfate A sodium salt, (C) traditional medium (DMEM with 10% DMSO and 10% serum), (D) control media (DMEM and 20% w/v Ficoll 70), and (E) DMEM with 10% w/v Ficoll 70 and 5% w/v chondroitin sulfate A sodium salt. The storage temperature was −80° C. and storage duration was four months. The significantly improved post-thaw viabilities from using the invented medium was demonstrated in FIG. 7 (two black bars). The outcome was similar to that in Example 5.

Bovine primary chromaffin cells stored in cryopreservation medium containing 20% w/v Ficoll 70 and either 5% or 10% w/v chondroitin sulfate A sodium salt demonstrated greater than 70% viability and cells stored in medium containing 10% w/v Ficoll 70 and 5% w/v chondroitin sulfate A sodium salt demonstrated about 30% survival. Meanwhile, cells stored in traditional medium containing 10% DMSO and 10% fetal bovine serum demonstrated about 20% survival and cells stored in medium containing 20% w/v Ficoll 70 alone demonstrated about 10% survival.

Example 7: The efficacy of the cryopreservation medium of the present invention in cryopreservation of human skin grafts, human corneal limbal tissues, and bovine adrenal gland tissues at −80° C.

The efficiency of using the medium of the present invention (DMEM containing 20% w/v Ficoll 70 and 5% w/v chondroitin sulfate A sodium salt) for the cryopreservation of donor tissues was evaluated.

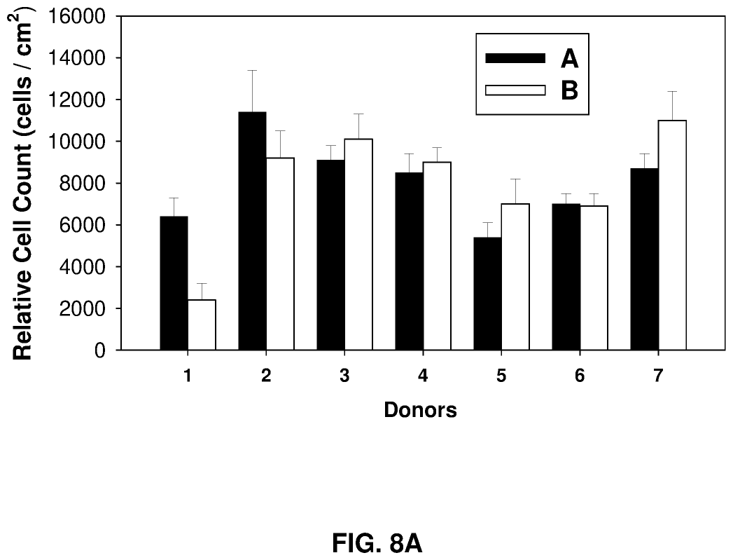

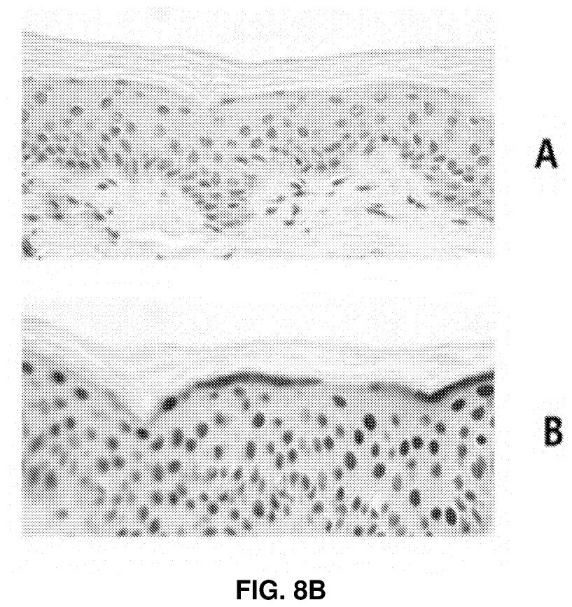

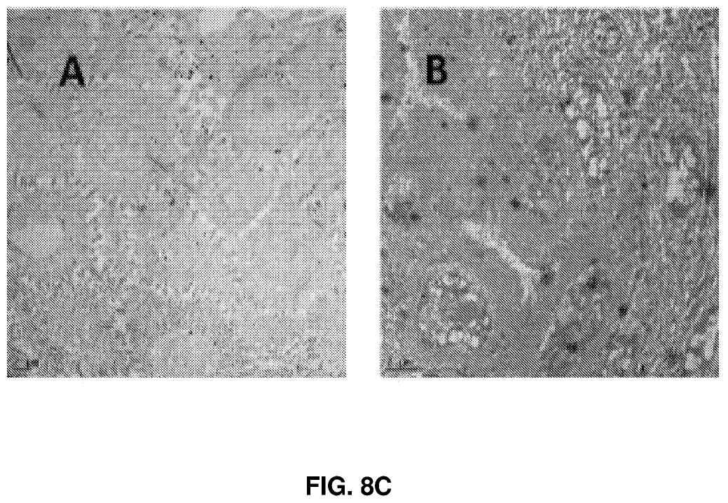

In particular, the efficiency of the medium of the present invention for cryopreservation of human skin grafts from seven different donors was tested, each skin graft having an intermediate split thickness of 0.5 mm. Each tissue (about 10 cm×10 cm in size) was mixed with two volumes of the medium of the present invention in a sterile freezing bag. The loaded freezing bags were first cooled in a −20° C. chest freezer overnight, and then transferred to a −80° C. freezer for storage. After one month storage at −80° C., the post-thaw functionalities of the skin grafts from the seven different donors were analyzed by standard PrestoBlue assays, tissue quality was evaluated by standard TUNEL staining, and tissue ultra-structures were studied by transmission electron microscopy (TEM). Similar tissues from the same donors were also frozen in standard medium containing 15% glycerol in Ringer's solution, as the traditional approach, for comparison. The results are shown in FIGS. 8A-8C. The test results show that the cryoprotection provided by medium of the present invention is either significantly better than (reducing cell apoptosis and ultra-structural damage) or comparable to (cell counts) the traditional medium including a high concentration of glycerol.

The medium of the present invention (DMEM containing 20% w/v Ficoll 70 and 5% w/v chondroitin sulfate A sodium salt) was evaluated for its effect on limbal tissue cryopreservation at −80° C. Two pairs of qualified human corneas were sent to a Washington University surgical team having expertise in limbal stem cell (LSC) transplantation. For each pair of corneas, one cornea was radially cut into four sections (quadruples), with each quadruple individually cryopreserved in a standard and sterile 15 ml cryovial (Nalgene™) containing 10 ml of the medium of the present invention. For the other cornea of the same pair, the quadruples were individually cryopreserved in the standard DMEM medium containing 5% DMSO and 10% FBS as the control. The tissues were also frozen at −20° C. overnight first, and then were stored at −80° C. for one week or one month, and then thawed. After thawing, for the quadruples of each cornea, one quadruple was fixed in a standard fixative for TUNEL staining, one quadruple fixed for transmission electron microscopy (TEM), and for the other two, each was radially cut into triplets (2×3=6 pieces in total) for in vitro culturing to determine proliferation of the LSC from the thawed tissues.

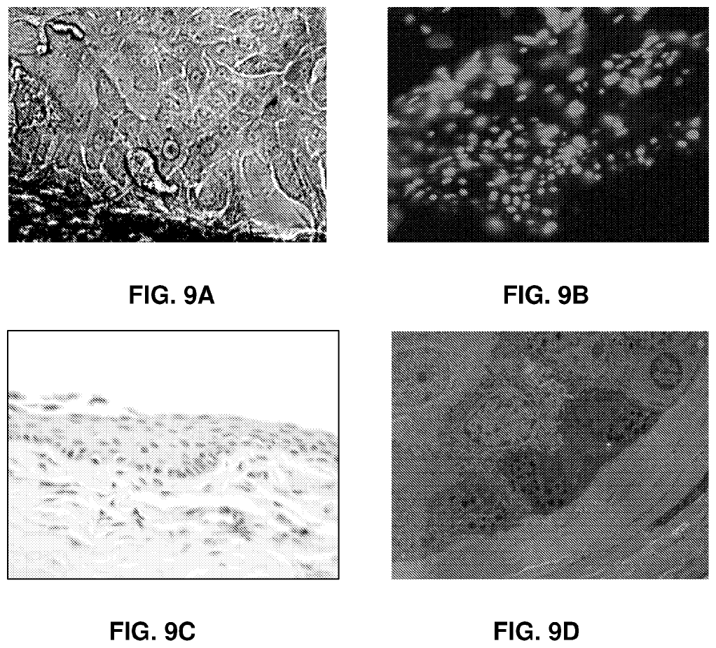

After one week of storage at −80° C., the LSC outgrowth was similar for the two groups, but after one month, the proliferation of the LSCs was much more prominent in the group cryopreserved by medium of the present invention. In particular, in the evaluation of six tissue pieces in each group, after 7 days of culturing, 6/6 of the group using medium of the present invention achieved outgrowth of LSC, in contrast to 3/6 of the DMSO+FBS group. Without being limited by theory it is believed that this difference is potentially due to the fact that the invented protocol does not involve the use of toxic DMSO. FIG. 9 shows representative results for cryopreservation of human limbal tissue at −80° C. for one month using the cryopreservation medium of the present invention. FIG. 9A: representative image showing limbal stem cell outgrowth from post-thaw tissues. FIG. 9B: representative image of cell staining (AE5 antibody for CK3) showing well differentiated cells. FIG. 9C: representative image showing TUNEL staining of thawed tissues, showing the normal limbal structure and cell health (few apoptotic cells). FIG. 9D: representative transmission electron microscopy showing the normal LSC ultrastructure after cryopreservation.

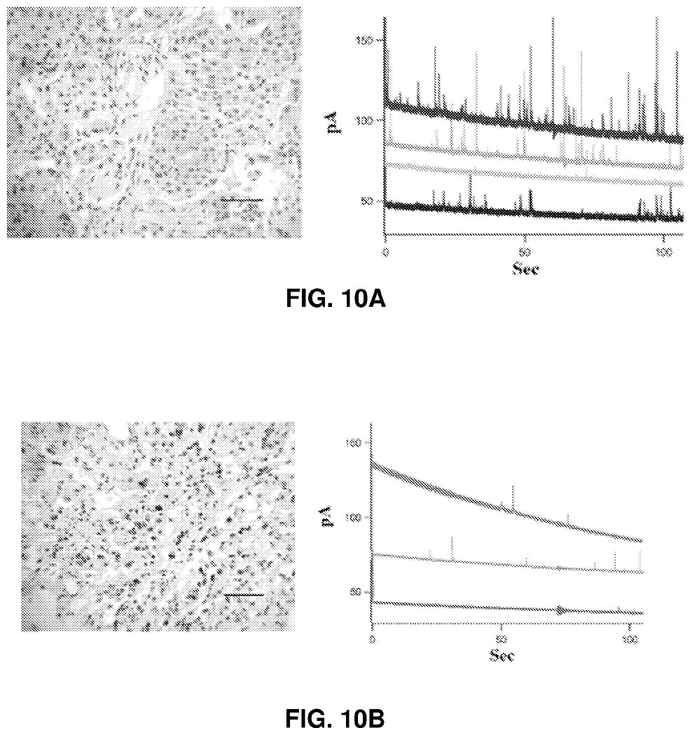

Considering the clinical value of cryopreservation of neuroendocrine tissues (e.g., pancreatic islets), the efficiency of medium of the present invention in long-term storage of medulla tissues of the adrenal glands was evaluated, to pave a path to future adoption of the medium of the present invention in transplantation of pancreatic islets. The medullae of the glands were processed into small pieces of approximately 2 mm on each side. Approximately 30-40 samples were transferred into one 15 ml cryovial containing 10 ml of the medium of the present invention as the storage medium, or into one 15 ml cryovial containing 10 ml of the tissue culture medium containing 10% DMSO and 10% FBS as the control. The cryovials were first frozen at −20° C. overnight, and then transferred to a −80° C. freezer for storage. After one year of storage at −80° C., the tissue quality was analyzed by TUNEL staining and chromaffin cell functionality was assessed by detection of single-vesicle catecholamine release using micro electrochemical microelectrodes. The typical results are shown in FIGS. 10A-B.

As can be seen, the post-thaw cell viability from the control group (FIG. 10B, from using the traditional medium) is poor and tissue structure is severely damaged, without detectable signal for catecholamine release. In contrast, the treatment using the medium of the present invention (FIG. 10A) results in well preserved tissue structure and cell viability and functionality. This study demonstrated the efficacy of the cryopreservation medium of the present invention in achieving high through-put for long-term storage of tissues.

Example 8: The efficacy of the cryopreservation medium of the present invention in cryopreservation of bioartificial tissues with examples of differentiated iPSC derived 2D RPE tissues and 3D neuronal tissues at −80° C.

The efficiency of the medium of the present invention (DMEM containing 20% w/v Ficoll 70 and 5% w/v chondroitin sulfate A sodium salt) in cryopreservation of iPSC derived bioartificial tissues was evaluated. Considering the success and simplicity of using standard 15 ml cryovials (2.5 cm in diameter and 5 cm in height) and the medium of the present invention for freezing small tissues, as shown above, it was decided to use the same cryovials for iPSC derived tissues, which are generally circular and 1 cm in diameter. The cooling procedure includes directly mounting the cryovials, which were loaded with 10 ml the medium of the present invention and one tissue, into a −80° C. freezer. The cooling rate of the tissues was estimated by inserting a thermal couple into the medium of the present invention at the bottom of the cryovials (because the density of the tissues is always greater than the density of the medium of the present invention). Within the typical temperature range of crystallization process, i.e., −1° C. to −40° C., the average cooling rate measured by this method was in the range of 1-2° C./min, which is also close to the optimal cooling rate for relatively small tissues. The warming/thawing process includes adding the frozen cryovials into a 37° C. water bath, with a warming rate of about 10° C./min. The 2D iPSC-derived, differentiated RPE tissues and 3D precursor cell-derived (ReN™ cells) differentiated neural constructs were produced by following standard protocols.

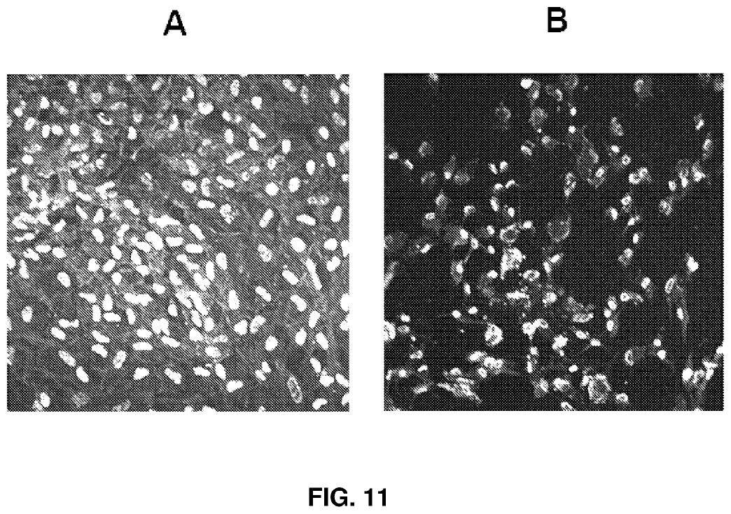

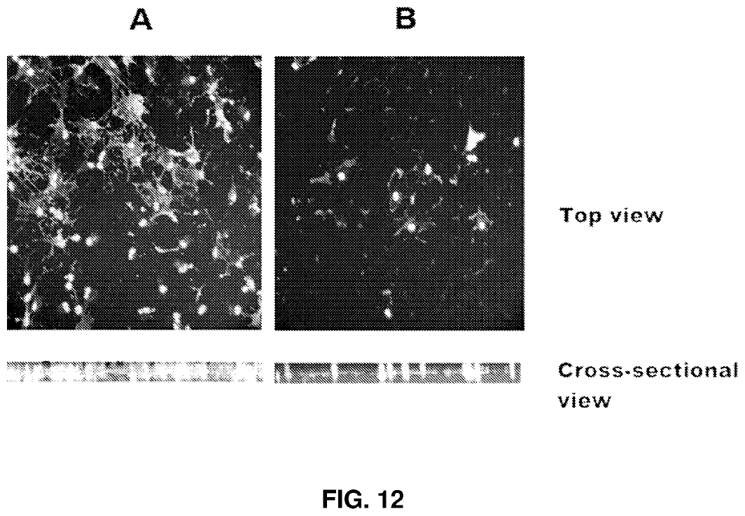

The tissues, together with 10 ml of the medium of the present invention or traditional medium containing 10% DMSO and 10% FBS in 15 ml cryovials, were directly cooled as described above, and stored in a −80° C. freezer. After two months of storage, the post-thaw viability was evaluated by standard staining for RPE and ReN cells and confocal microscopy, with representative outcomes shown in FIGS. 11A-11B and FIGS. 12A-12B. The groups using the medium of the present invention (FIGS. 11A and 12A) resulted in much higher viability and tissue quality than the traditional medium groups (FIGS. 11B and 12B), and are comparable to unfrozen controls.

The efficiency of using the medium of the present invention for longer storage (e.g., 6 and 12 months) will also be investigated.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference throughout the specification to “an aspect”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the present invention, but that the invention will include all embodiments falling within the scope of the appended claims. Any combination of the above-described elements in all possible variations thereof is encompassed by the invention unless otherwise indicated herein or otherwise clearly contradicted by context.

1. A cryopreservation medium comprising:
a first cryoprotective particle or macromolecule;
a second cryoprotective particle or macromolecule; and
an aqueous liquid,
wherein the first cryoprotective particle or macromolecule is hydrophilic and has a spherical shape when dissolved or suspended in the aqueous liquid, and
wherein the second cryoprotective particle or macromolecule has an affinity for the first cryoprotective particle or macromolecule and an affinity for a plasma membrane of a cell or a lipid membrane of a lipid membrane bound biological structure.

2. The cryopreservation medium of claim 1, wherein the amount of the first cryoprotective particle or macromolecule is about 10% (w/v) to about 50% (w/v).

3. (canceled)

4. The cryopreservation medium of claim 1, wherein the amount of the second cryoprotective particle or macromolecule in the medium is about 1% (w/v) to about 15% (w/v).

5. (canceled)

6. The cryopreservation medium of claim 1, wherein the cryopreservation medium comprises substantially no cell permeating cryoprotectant.

7. The cryopreservation medium of claim 1, wherein the cryopreservation medium comprises less than 5% w/v of a cell permeating cryoprotectant comprising dimethyl sulfoxide, glycerol, ethylene glycol, propanediol, or a combination thereof.

8.-9. (canceled)

10. The cryopreservation medium of claim 1, wherein the first cryoprotective particle or macromolecule comprises a spherical hydrophilic polysaccharide, a polymerized cyclodextrin, a polymerized saccharide, a globular protein, a spherical glycoprotein comprising oligosaccharide chains attached to an outer surface of a globular protein, a globular protein derivative, a globular polypeptide, a spherical nucleic acid, a globular protein having oligosaccharide chains attached to the outer surface of the globular protein, a spherical hydrophilic polysaccharide comprising a copolymer of sucrose and epichlorohydrin or a combination thereof.

11.-12. (canceled)

13. The cryopreservation medium of claim 10, wherein the spherical hydrophilic polysaccharide has an average molecular weight of about 5,000 Da to about 1,000,000 Da.

14. (canceled)

15. The cryopreservation medium of claim 1, wherein the second cryoprotective particle or macromolecule comprises a glycosaminoglycan, a modified glycosaminoglycan, chondroitin sulfate A, chondroitin sulfate C, chondroitin sulfate D, dermatan sulfate, a salt thereof, or a combination thereof.

16.-17. (canceled)

18. A method of protecting a lipid membrane of a lipid membrane bound biological structure, comprising:
contacting the lipid membrane bound biological structure with a cryopreservation medium prior to cooling the lipid membrane bound biological structure to a temperature of about −70° C. to about −273° C.,
wherein cubic ice is formed around the lipid membrane at the temperature of about −70° C. to about −273° C.

19. A method for cryopreservation of a lipid membrane bound biological structure, comprising:
contacting the lipid membrane bound biological structure with the cryopreservation medium of claim 1 to form a treated lipid membrane bound biological structure;
cooling the treated lipid membrane bound biological structure to a temperature of about −70° C. to about −273° C. to freeze the treated lipid membrane bound biological structure and form a frozen lipid membrane bound biological structure; and
maintaining the frozen lipid membrane bound biological structure at the temperature of about −70° C. to about −273° C.

20. The method of claim 19, wherein the lipid membrane bound biological structure comprises a cell, a tissue, an extracellular vesicle, a lipid bound vesicle, an organ, an organism, or a combination thereof.

21. The method of claim 19, further comprising freezing the treated lipid membrane bound biological structure at a temperature of about −18° C. to about −25° C. for about 6 to about 12 hours prior to the cooling to the temperature between about −70° C. and about −273° C.

22. (canceled)

23. The method of claim 19, wherein the cryopreservation medium and the lipid membrane bound biological structure are contacted at room temperature for a period of about 30 minutes to about 120 minutes prior to the cooling.

24. The method of claim 19, wherein the frozen lipid membrane bound biological structure remains substantially intact when maintained at the temperature of about −70° C. to about −273° C. for a time period of at least three weeks.

25. (canceled)

26. The method of any of claims 19-25 claim 19, wherein a volume ratio of the cryopreservation medium to the lipid membrane bound biological structure is about 1:1 to about 10 10,000:1.

27. (canceled)

28. The method of claim 19, wherein the contacting comprises adding an amount of the cryopreservation medium to a two-dimensional or three-dimensional culture comprising the lipid membrane bound biological structure and a culture medium, and optionally removing the culture medium from the two-dimensional or three-dimensional culture prior to the contacting.

29. The method of claim 19, wherein the cooling is performed at a rate of about 0.1° C./min to about 100° C./min.

30. (canceled)

31. The method of claim 19, wherein the lipid membrane bound biological structure comprises a plurality of cells, and a post-thaw survival rate of the frozen plurality of cells is greater than or equal to about 60% of the total number of viable cells prior to the cooling.

32. (canceled)

33. The method of claim 31, wherein the lipid membrane bound biological structure is a tissue comprising the plurality of cells, an organ comprising the plurality of cells, or an organism comprising the plurality of cells.

34. The method of claim 31, wherein the plurality of cells comprises mammalian cells, insect cells, plant cells, or a combination thereof.

35.-36. (canceled)
